(19) United States
(12) Patent Application Publication
(10) Pub. No.: US 2008/0174892 A1
(43) Pub. Date: Jul. 24, 2008

(54) AUTOMOTIVE FIXTURE MOUNTING BRACKET

(76) Inventor: Michael A. Giordano, Rohnert Park, CA (US)

Correspondence Address: DERGOSITS & NOAH LLP, Suite 1450, Four Embarcadero Center, San Francisco, CA, 94111, US

(21) Appl. No.: 12/016,905

(22) Filed: Jan. 18, 2008

Related U.S. Application Data
(60) Provisional application No. 60/881,783, filed on Jan. 19, 2007.

(51) Int. Cl. G02B 7/182

(52) U.S. Cl. 359/841; 359/872

(57) ABSTRACT

A bracket for releasably appending a fixture to the rear view mirror assembly of the vehicle. The rear view mirror assembly includes a windshield mounting bracket pivotably supporting a mirror shaft on its first end and a rear view mirror on its second end. The bracket includes a top element and bottom element sized to, upon assembly, surround and capture a section of the mirror shaft between its first and second ends. An L-shaped bracket is further provided joining either a stand off or the top element of the bracket to position a fixture adjacent the rear view mirror and to be visible to a driver while operating the vehicle.

### PRIOR APPLICATIONS

This patent application claims priority to U.S. Patent Application Ser. No. 60/881,783, entitled Automotive Fixture Mounting Bracket, filed on Jan. 19, 2007.

### TECHNICAL FIELD

The present invention relates to a mounting bracket for mounting a fixture to the interior of a vehicle, and specifically, on the shaft appending the vehicle's rear view mirror to the windshield or supporting structure. By employing the present mounting bracket, the fixture can be positioned appropriately for displaying vital information to the driver while enabling the rear view mirror to be appropriately positioned for functional use.

### BACKGROUND OF THE INVENTION

Vehicle operators oftentimes have the need to provide one or more after market products to assist in vehicle management and operation. These can include such diverse products as engine monitor devices, global navigation systems and radar detectors. Current mounting devices generally include suction cups which are intended to adhere to the dashboard or windshield surfaces of a vehicle. Anyone who has had experience with such attachment means would readily appreciate their shortcomings for suction cups and the like tend to clutter any interior surface to which they are applied, oftentimes obscure an operator's vision and lose contact surface adhesion repeatedly.

Alternatively, there exist mounting brackets which enable an operator to physically screw down or permanently adhere a secondary market fixture to a vehicle's interior. Although inadvertent dislodgement is not the issue in using such fixtures, one is faced with the permanent disfigurement of the vehicle's interior which not only adversely impacts the resale value of the vehicle but also comprises its aesthetic appearance in the event that the primary fixture is to be removed or replaced.

There does exist a need for an appropriate fixture mounting bracket which overcomes the various shortcomings outlined above.

### SUMMARY OF THE INVENTION

A bracket for releasably appending a fixture to a rear view mirror assembly of a vehicle, said rear view mirror assembly comprising a windshield mounting bracket pivotably supporting a mirror shaft on a first end thereof, said mirror shaft in turn pivotably supporting a rear view mirror on a second end thereof, said bracket comprising a top element and bottom element, sized to, upon assembly, surround and capture a section of said mirror shaft between its first and second ends, an L-shaped bracket joined to said top element sized to position a fixture adjacent said rear view mirror to be visible to a driver while operating said vehicle.

### BRIEF DESCRIPTION OF THE FIGURES

FIG. 1 is a side view of the present invention installed on a rear view mirror assembly intended to be situated in a vehicle.

FIG. 2 is a front plan view of a first embodiment of the present invention.

FIG. 3 is a front plan view of yet another embodiment of the present invention.

### DETAILED DESCRIPTION OF THE INVENTION

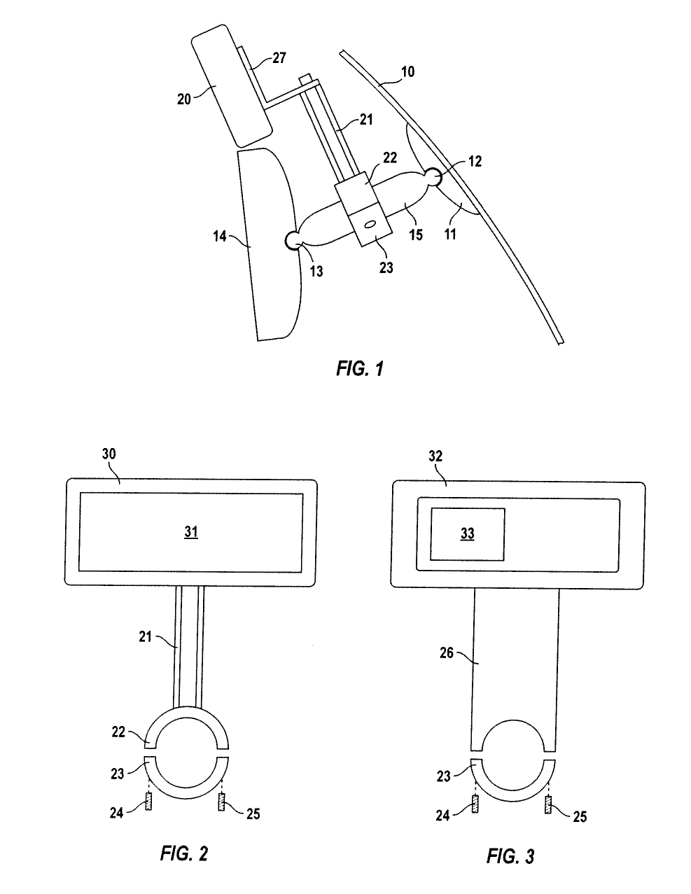

Applicant previously submitted U.S. application Ser. No. 11/412,513 disclosing a means to releaseably encapsulate a fixture of an irregular shape to the interior of a vehicle. This fixture can be employed with the present invention although the present invention can be used without the subject encapsulation fixture of the referenced pending application. The present invention can be more readily appreciated when considering FIGS. 1-3 appended hereto.

Turning first to FIG. 1, a side view of the present invention employed with a standard rear view mirror assembly is noted. As is typically the case, rear view mirror 14 is appended to windshield 10 via mounting bracket 11 which supports first pivot 12. Mirror shaft 15 is configured to rotate about pivot 12 in the form of a ball and socket while rear view mirror 14 is configured to rotate about second pivot 13. As such, rear view mirror 14 can be changed in elevation via first pivot 12 and its angular orientation changed via second pivot 13 to enhance the flexibility of such an assembly.

The present invention comprises a fixture whose component parts can be visualized in reference to FIGS. 1-3. Specifically, fixture 20 can be supported by L-shaped bracket 27. Attachment can be made permanently by adhering or screwing the back of fixture 20 or its encapsulation assembly (not shown) to L-shaped mounting bracket or, perhaps more conveniently, a first sheet of hook and loop fastener 31 (FIG. 2) can be permanently adhered to L-shaped bracket 27 on surface 30 thereof while a second sheet of hook and loop fastener can be permanently adhered to the rear face of fixture 20 (not shown). In addition, an opening 33 can be configured within surface 32 of L-shaped bracket 27 in the event that a suitable electrical connection is to be made through the rear of fixture 20 through the L-shaped bracket.

L-shaped bracket 27 is appended to rear view mirror mounting shaft 15 by standoff 21. Standoff 21 is, in turn, connected to top element 22 of the disclosed ring mount. As noted by reference to FIG. 2, the entire assembly is appended to rear view mirror shaft 15 by applying allen screws 24 and 25 through the lower half 23 of the ring mount which passes there through to be screwed within suitable threaded receiving holes in upper ring mount half 22.

As an alternative embodiment, standoff 21 can be eliminated while the upper ring half of the connector assembly can be extended as element 26 of FIG. 3 to connect directly to L-shaped mounting bracket 27.

As noted, the present invention provides certain inherent advantages not achievable by practicing the prior art. It is first noted that fixture 20 can be positioned to directly face a vehicle operator by appropriately moving mirror support shaft 15 on front pivot 12. Thus, not only the height but orientation of fixture 20 can be appropriately adjusted. Thereupon, mirror 14 can be suitably adjusted to perform its rear view mirror function by pivoting mirror 14 on second pivot 13.

In addition, it should be quite apparent that not only does the present invention provide flexibility not achievable by the prior art but in the event that a user wishes to remove fixture 20 and its entire mounting assembly from the interior of a vehicle, one need only unscrew allen screws 24 and 25 from lower ring half 23 leaving the vehicle without any trace that the fixture was ever made a part of the vehicle's interior. Further, one is never compromised as to vehicle visibility or need be concerned that a releaseable fixture mounting device, such as a suction cup would inadvertently fall from a support surface.

It also must be appreciated that the present mounting bracket can remain positioned upon rear view mirror shaft 15 while simply removing one fixture 20 and replacing it by another fixture at the mere whim of an operator. If hook and loop fasteners are employed, one would merely remove a first fixture 20, such as a radar detector, and replace it with a GPS navigation system without having to in any fashion replace or otherwise alter the mounting bracket. Such flexibility is unachievable by devices of the prior art.

What is claimed is:

1. A bracket for releaseably appending a fixture to a rear view mirror assembly of a vehicle, said rear view mirror assembly comprising a windshield mounting bracket pivotably supporting a mirror shaft on a first end thereof, said mirror shaft in turn pivotably supporting a rear view mirror on a second end thereof, said bracket comprising a top element and bottom element, sized to, upon assembly, surround and capture a section of said mirror shaft between its first and second ends, a stand off releasably connected to said top element, an L-shaped bracket joined to said stand off sized to position a fixture adjacent said rear view mirror to be visible to a driver while operating said vehicle.

2. The bracket of claim 1 wherein said L-shaped bracket comprises a first surface for joining it to said stand off and a second surface for releaseably supporting said fixture.

3. The bracket of claim 2 wherein said fixture is appended to said second surface by hook and loop fasteners.

4. The bracket of claim 2 wherein said second surface is configured with an opening therein for passage of an electric connector.

5. The bracket of claim 1 wherein said top and bottom elements comprise half circles releaseably joined to one another around said mirror shaft.

6. A bracket for releasably appending a fixture to a rear view mirror assembly of a vehicle, said rear view mirror assembly comprising a windshield mounting bracket pivotably supporting a mirror shaft on a first end thereof, said mirror shaft in turn pivotably supporting a rear view mirror on a second end thereof, said bracket comprising a top element and bottom element, sized to, upon assembly, surround and capture a section of said mirror shaft between its first and second ends, an L-shaped bracket joined to said top element sized to position a fixture adjacent said rear view mirror to be visible to a driver while operating said vehicle.

7. The bracket of claim 6 wherein said L-shaped bracket comprises a first surface for joining it to said stand off and a second surface for releaseably supporting said fixture.

8. The bracket of claim 7 wherein said fixture is appended to said second surface by hook and loop fasteners.

9. The bracket of claim 7 wherein said second surface is configured with an opening therein for passage of an electric connector.

10. The bracket of claim 6 wherein said top and bottom elements comprise half circles releaseably joined to one another around said mirror shaft.
